(19) United States
(12) Patent Application Publication
(10) Pub. No.: US 2004/0166261 A1
(43) Pub. Date: Aug. 26, 2004

(54) Heat-shrinkable packaging receptacle

(76) Inventors: Gregory Robert Pockat, Ripon, WI (US); Thomas Andrew Schell, Oshkosh, WI (US)

Correspondence Address: Cedric M. Richeson, Bemis Company, Inc., Patent and Trademark Department, 2200 Badger Avenue, Oshkosh, WI, 54903, US

(21) Appl. No.: 10/371,950

(22) Filed: Feb. 20, 2003

(51) Int. Cl. F16B 4/00

(52) U.S. Cl. 428/34.9

(57) ABSTRACT

An individual end-sealed packaging receptacle, such as a bag, formed from a sheet of heat-shrinkable film having a first edge and an opposing second edge. The packaging receptacle includes a first seal bonding the first edge and second edge to define a tube member having a first bag wall, a second bag wall, first and second opposing lay-flat bag edges, an end and an open mouth. The packaging receptacle includes a second seal through the first and second bag walls, extending laterally across the width of both the first and second walls and thereby closing the end. A method of forming a individual, end-sealed, heat-shrinkable packaging receptacle is also disclosed.

### BACKGROUND OF THE INVENTION

This invention relates the shrink packaging of articles, particularly food articles such as poultry, cheese, primal or subprimal meat cuts, fresh red meat and other processed meat, fruits, vegetables, breads and food products. Shrink packaging refers to the use of a packaging film manufactured in such a way that when it is exposed to a certain amount of heat, it will contract, preferably in both directions, reducing its overall surface area. When this type of film is wrapped around an object, sealed around its edges and passed through a heated shrink tunnel where the package is exposed to an elevated temperature, the film will react to the heat and contract around the object. Depending on the respective application, the air trapped within the package may be evacuated prior to final sealing, or small holes may be provided through the film to allow air to escape during the heat shrinking process. This process results in an attractive skin-tight package. Articles packaged using shrink packaging are numerous and can include food articles, such as frozen pizzas, cheese, poultry, fresh red meat, and processed meat products.

The shrink packaging of food articles such as poultry, cheese, fresh red meat, and processed meat products requires tough, puncture resistant, yet flexible, film materials suitable for use in fabricating individual heat-shrinkable packaging receptacles, such as pouches and bags for packaging such food articles. Generally, the shrink packaging method of food articles is predicated upon the heat-shrinking property of the receptacle by placing a given food article or articles into an individual receptacle, evacuating the receptacle to remove air so the receptacle collapses, heat sealing across the receptacle's opening or mouth to close the receptacle and thereafter exposing the receptacle to a heat source such as a flow of hot air, infrared radiation, hot water, and the like, thereby causing the receptacle to shrink and come into intimate contact with the contours of the food article or articles. The packaged article prepared by this packaging method has an attractive appearance which adds to the commodity value of the wrapped article, its contents are kept in a hygienic condition, and it allows shoppers to examine the quality of the contents of the packaged article. Packaging in this fashion also excludes air from the package to prolong shelf life.

Typically, individual bags or pouches for packaging food articles include one to three sides heat sealed by the bag manufacturer leaving one side open to allow product insertion. Such individual bags are generally manufactured from shrink films by producing a seamless tube of heat-shrinkable film having a desired diameter and heat sealing one end of a length of the tubular film and cutting off the tube portion containing the sealed portion, thereby forming a bag which, when it is laid flat, has a bottom edge formed by the heat seal, an open mouth opposite the sealed bottom and two seamless side edges formed by the fold produced when the tube is laid flat. Another method of forming bags from a seamless tube comprises making two spaced-apart transverse seals across the tube and cutting open the side of the tube. If flat sheets of film are used, bags are formed therefrom by heat sealing three edges of two superimposed sheets of film or by end-folding a flat sheet and sealing two sides.

Manufacturing bags from a seamless tube requires that the tube be extruded to a specified width for the intended end use. Thus, fabricating small diameter tubes for small width bags does not utilize the full capacity of the film manufacturing equipment and is thus not economical. Seamless tube sizes are also limited by the manufacturing equipment in how small the width can be made. The manufacture of individual bags by superimposing two sheets and sealing about three edges requires costly machinery to handle the separate sheets, properly align the sheets and provide seals around the several edges. Additionally, having a third sealed edge (four sealed edges when closed) increases the risk of a seal failure during the shrinking process. Folding a sheet of film and sealing two sides creates a double thickness of film at the seals which undesirably protrude from the side of the finished package.

Accordingly, although the known shrink bags meet many of the requirements for packaging applications, a need still exists for an improved heat-shrinkable bag structure that can be economically fabricated and sealed using standard bag sealing machinery at the place of packaging.

### SUMMARY OF THE INVENTION

In accordance with the present invention, there is provided an individual end-sealed packaging receptacle, such as a bag, formed from a sheet of heat-shrinkable film having a first edge and an opposing second edge. The packaging receptacle includes a first seal bonding the first edge and second edge to define a tube member having a first bag wall, a second bag wall, first and second opposing lay-flat bag edges, an end and an open mouth. The packaging receptacle includes a second seal through the first and second bag walls, extending laterally across the width of both the first and second walls and thereby closing the end.

### BRIEF DESCRIPTION OF THE DRAWING FIGURES

FIG. 1 illustrates a schematic view of an end-seal, shrink bag having a lap seal according to the present invention, in a slightly open position from a lay-flat position.

FIG. 2 illustrates a transverse cross-sectional view of the bag illustrated in FIG. 1, taken through section 2-2 of FIG. 1.

FIG. 3 illustrates a schematic view of an end-seal, shrink bag having a fin seal according to the present invention, in a slightly open position from a lay-flat position.

FIG. 4 illustrates a transverse cross-sectional view of the bag illustrated in FIG. 3, taken through section 4-4 of FIG. 3.

FIG. 5 illustrates a schematic view of an end-seal, shrink bag having a butt-seal according to the present invention, in a slightly open position from a lay-flat position.

FIG. 6 illustrates a transverse cross-sectional view of the bag illustrated in FIG. 5, taken through section 6-6 of FIG. 5.

FIG. 7 illustrates a preferred three-layer film structure for forming bags according to the present invention.

FIG. 8 is a schematic representation of a preferred method of manufacturing films for use with the present invention.

FIG. 9 illustrates a preferred seven-layer film structure for forming bags according to the present invention.

### DETAILED DESCRIPTION OF THE PREFERRED EMBODIMENTS

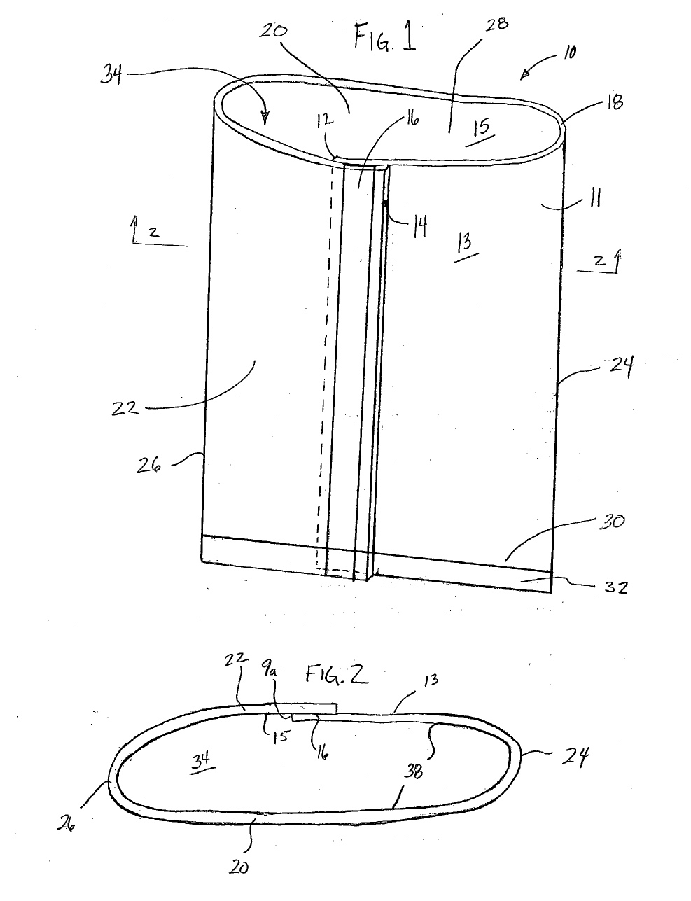

A preferred embodiment of the heat-shrinkable packaging receptacle of the present invention is shown in FIGS. 1 and 2 generally as bag 10. The bag 10 is formed from a sheet of heat-shrinkable film 11 having a first edge 12, a second edge 14, a top surface 13 and a bottom surface 15. The bag 10 includes a first seal 16 bonding the first and second edges 12 and 14 in an overlapping arrangement, or lap seal, from the top of the bag to the bottom. A tube member 18 is formed, shown in FIGS. 1 and 2 in a partially lay-flat orientation, having a first bag wall 20, a second bag wall 22, a first bag edge 24, a second bag edge 26, an opening 28 and a bag end 30. In other words, the first and second edges 12 and 14 are placed in an overlapping arrangement and a seal, such as a heat seal, is provided between the top surface 13 of the first edge 12 and bottom surface 15 of the second edge 14 such that the top surface 13 of the first edge 12 is sealed in face-to-face contact with the bottom surface 15 of the second edge. The bag 10 includes a second seal 32 provided through the first and second bag walls 20 and 22 and extending laterally across the bag 10 from the first bag edge 24 to the second bag edge 26, thereby closing the bag end 30 and defining a product receiving chamber 34.

Although the first seal 16 is illustrated as being positioned between the first and second tube edges 24 and 26 and running parallel thereto, one skilled in the art will appreciate in view of the present disclosure that the position of the first seal 16, when the bag 10 is in a lay-flat orientation, may be any desired position from first edge 24 to second edge 26 of either first or second bag walls 20 and 22, as well as being positioned at either of the first and second bag edges 24 and 26. The second seal 32 is illustrated as being straight and extending perpendicular to the first seal 16; however, the skilled artisan will appreciate that the second seal 32 may take any shape, so long as the second seal 32 operates to close the bag end 30 and thereby define a product receiving chamber 34. For example, common seal configurations include straight, or linear, seals which usually extend perpendicular to the tube edges 24 and 26 (the tube edges 24 and 26 generally extend parallel to each other), and also include nonlinear or curved edges, e.g., such as those described in U.S. Pat. No. 5,149,943, which patent is hereby incorporated by reference in its entirety. Both linear and nonlinear seals may be made by any suitable sealing method known, including hot bar and impulse sealing.

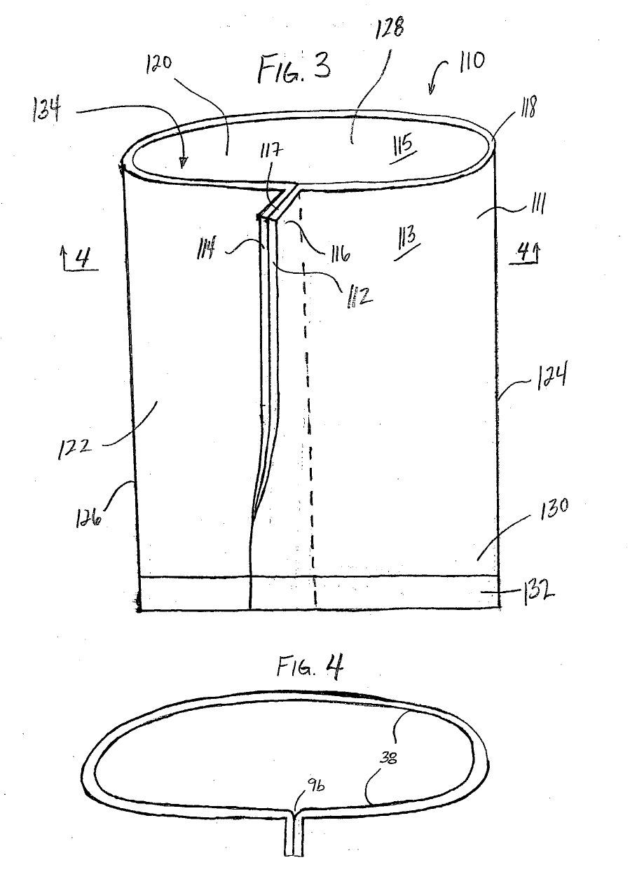

A second embodiment of the heat-shrinkable packaging receptacle of the present invention is illustrated in FIGS. 3 and 4 generally as bag 110. The bag 110 is formed from a sheet of heat-shrinkable film 111 having a first edge 112, a second edge 114, a top surface 113 and a bottom surface 115. The bag 110 includes a first seal 116 bonding the first and second edges 112 and 114 in an abutting arrangement, or fin seal, thereby defining a tube member 118. To form the first seal 116, the first and second edges 12 and 14 are brought together such that the bottom surface 115 of both the first and second edges 112 and 114 is placed in face-to-face contact and a seal, such as a heat seal, is provided therebetween. The tube member 118 is shown in FIGS. 3 and 4 in a partially lay-flat orientation, defining a first bag wall 120, a second bag wall 122, a first bag edge 124, a second bag edge 126, an opening 128 and a bag end 130. The bag 110 includes a second seal 132 provided through the first and second bag walls 120 and 122 extending laterally across the bag 110 from the first bag edge 124 to the second bag edge 126, thereby closing the bag end 130 and defining a product receiving chamber 134.

Again, although the first seal 116 has been illustrated as being positioned between the first and second tube edges 124 and 126, one skilled in the art will appreciate in view of the present disclosure that the location of the first seal 116, when the bag 110 is in a lay-flat orientation, may be any desired position from first edge 124 to second edge 126 of either first or second tube walls 120 and 122, as well as being positioned at either of the first and second edges 124 and 126. Since the first seal 116 forms a fin 117 that extends outwardly from the tube member 118, the first seal 116 is preferably positioned at a point between the first and second tube edges 124 and 126 at or near the middle of a bag wall. In this manner, the fin 117 may be folded over flat against the respective bag wall from which it extends and the second seal 132 and final closing seal (not shown) will operate to maintain the fin 117 in such a folded position. This advantageously eliminates an unwanted, unaesthetic fin seal at the side edge of a packaged product. Similar to second seal 32, the second seal 132 is illustrated as being straight and extending perpendicular to the first seal 116. The skilled artisan will appreciate that the second seal 132 may take any shape, such as a curved shape, so long as the second seal 132 operates to close the bag end 130 and thereby define a product receiving chamber 134, as described with respect to the second seal 32.

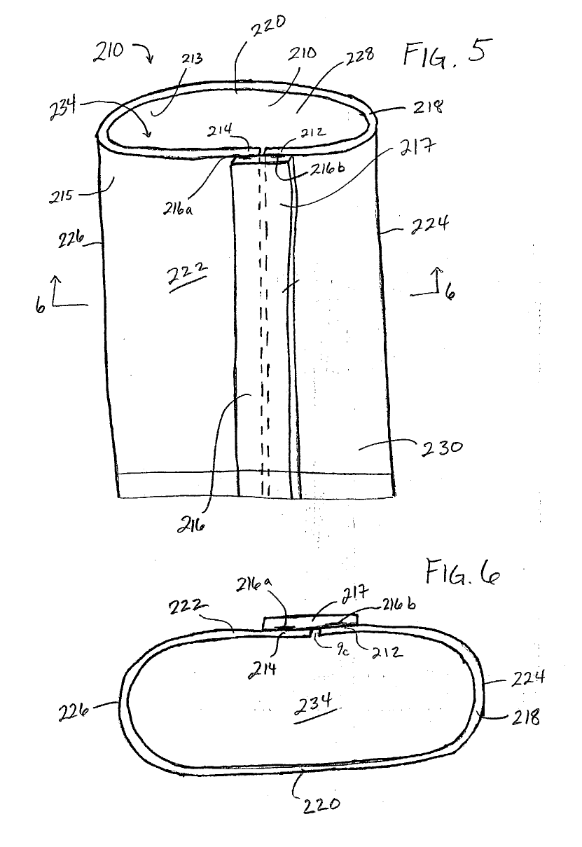

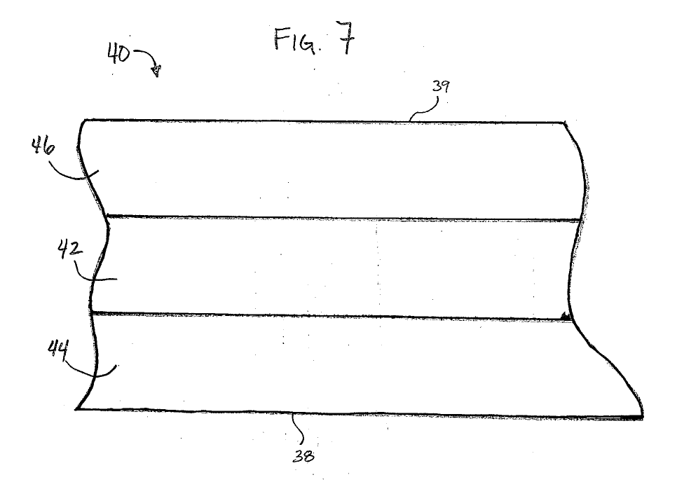

Another embodiment of the present invention is illustrated in FIGS. 5 and 6 generally as bag 210. Bag 210 is formed from a sheet of heat-shrinkable film 210 having a first edge 212, a second edges 214, an inner surface 213 and an outer surface 215. The bag 210 includes a first seal 216 comprising a butt-seal, that bonds the first and second edges 212 and 214 in a longitudinally abutting relationship with or without directly bonding surfaces of the first and second edges 212 and 214 together. The first seal 216 preferably includes a butt-seal tape 217, one side of which is sealed to the outer surface 215 of the first edge 212 by seal 216a, while an opposing side of the tape 217 is sealed to the outer surface of the second edge by seal 216b, seals 216a and 216b being in regions adjacent to and along the first and second edges 212 and 214. The first seal 216 defines a tube member 218, shown in FIGS. 5 and 6 in a partially lay-flat orientation, having a first bag wall 220, a second bag wall 222, a first bag edge 224, a second bag edge 226, an opening 228 and a bag end 230. The bag 210 includes a second seal 232 provided through the first and second bag walls 220 and 222 extending laterally across the bag 210 from the first bag edge 224 to the second bag edge 226, thereby closing the bag end 230 and defining a product receiving chamber 234.

The film used to fabricate the bags of the present invention may be multilayer or monolayer flexible, heat-shrinkable film manufactured by any known process. For example, in commercial poultry packaging operations, monolayer films made from polyethylene and/or ethylene-vinyl acetate copolymers, and multilayer films containing polyethylene and/or ethylene-vinyl acetate copolymers are used extensively. Likewise, in the packaging of fresh red meat and processed meat products, multilayer heat-shrinkable films containing polyethylene and/or ethylene-vinyl acetate copolymers in one or more layers of the films are commonly employed. Preferred films may also provide a beneficial combination of one or more or all of the below noted properties including high puncture resistance (e.g. as measured by the ram and/or hot water puncture tests), high shrinkage values, low haze, high gloss, and high seal strengths. The film and/or bags may also include an indicia, such as they may be printed. For example, bags according to the invention may preferably include an indicia indicating that the bag includes a bone-containing product. It may be desirable for applications wherein the film is printed to corona treat the film surface to improve ink adhesion. Since corona treated surfaces do not normally heat seal as well as untreated surfaces, it may be desirable to corona treat only those portions that will not form part of a heat seal or to limit the treated area of the film to minimize adverse interaction with later sealed areas. For example, a center portion of the film may be corona treated, while those portions along each of the machine direction edges of the film are not. In this manner, those portions along each machine direction edge, that are sealed together to form the first seals 16 or 116 as described above, are not corona treated and should not be adversely affected.

Preferably, the film may have an unrestrained shrinkage of at least 20% in at least one direction and more preferably 35% or more in one or both the machine and transverse directions. Free shrink is measured by cutting a square piece of film measuring 10 cm in each of the machine and transverse directions. The film is immersed in water at 90° C. for five seconds. After removal from the water the piece is measured and the difference from the original dimension is multiplied by ten to obtain the percentage of shrink.

Although the films used in the bag according to the present invention can be monolayer or multilayer films, the bags are preferably formed of a multilayer film having 2 or more layers; more preferably 3 to 9 layers; and still more preferably 3 to 5 to 7 layers. Since the inventive bags are primarily intended to hold food products after evacuation and sealing, it is preferred to use a thermoplastic film which includes an oxygen and/or moisture barrier layer. The terms “barrier” or “barrier layer” as used herein means a layer of a multilayer film which acts as a physical barrier to moisture or oxygen molecules. Advantageous for packaging of oxygen sensitive materials such as fresh red meat, a barrier layer material in conjunction with the other film layers will provide an oxygen gas transmission rate(O₂GTR) of less than 70 (preferably 45 or less, more preferably 15 or less ) cc per square meter in 24 hours at one atmosphere at a temperature of 73° F. (23° C.) and 0% relative humidity.

The bags 10, 110 and 210 are preferably fabricated continuously from a continuous sheet or roll stock. The roll stock is slit to a desired width and fed to the bag making equipment, the machine direction edges of the film are brought together and sealed longitudinally, either with a lap seal (bag 10), fin seal (bag 110) or butt-seal (bag 210) to form a continuous single-seamed tube, or tube member. A transverse seal is made across the tube and the section including the transverse seal is severed from the continuous tube to form the individual bag.

The type of first seal 16, 116 or 216 incorporated into the bags of the present invention will need to be taken into account when selecting a suitable film. Generally, heat seals are made by supplying sufficient heat and pressure between two polymeric film layer surfaces for a sufficient amount of time to cause a fusion bond between the polymeric film layers. Common methods of forming heat seals include hot bar sealing, wherein adjacent polymeric layers are held in face-to-face contact by opposing bars of which at least one is heated, and impulse sealing, wherein adjacent polymeric layers are held in face-to-face contact by opposing bars of which at least one includes a wire or ribbon through which electric current is passed for a very brief period of time to cause sufficient heat to cause the film layers to fusion bond. Less area is generally bonded with an impulse seal relative to a hot bar seal, thus the performance of the film's sealing layer is more critical. However, an impulse seal is generally more aesthetic since less area is used to form the bond. First seal 16, or lap seal, requires that the top surface 13 and bottom surface 15 be capable of forming a suitable heat seal therebetween. If a first seal 116, or fin seal, is to be formed, only the bottom surface 115 need be capable of forming a suitable heat seal, since the interfacial bond will be formed between the same surface or layer. If a first seal 216, or butt-seal, is formed, then both the top surface and bottom surfaces must be capable of forming a suitable heat seal. Likewise, the butt-seal tape 217, must also be capable of forming a suitable heat seal with the top surface or a suitable adhesive must be employed to adhere the tape 217 to the top surface 13 or bottom surface 15, depending on whether the tape 217 is place on the inside or outside of the bag 110.

A preferred multilayer barrier film structure for use with the present invention is shown in FIG. 7 generally as 40. When an oxygen barrier layer 42 is needed, it is usually provided as a separate layer of a multilayer film, most commonly as a core layer sandwiched between an inner heat sealing layer 44 and an outer layer 46, though additional layers may also be included, such as tie or adhesive layers as well as layers to add or modify various properties of the desired film, e.g., heat sealability, toughness, abrasion resistance, tear-resistance, heat shrinkability, delamination resistance, stiffness, moisture resistance, optical properties, printability, etc. Oxygen barrier materials which may be included in the films utilized for the inventive bags include ethylene vinyl alcohol copolymers (EVOH), polyacrylonitriles, polyamides and vinylidene chloride copolymers (PVDC). Preferred oxygen barrier polymers for use with the present invention are vinylidene chloride copolymers or vinylidene chloride with various comonomers such as vinyl chloride (VC-VDC copolymer) or methyl acrylate (MA-VDC copolymer), as well as EVOH. A specifically preferred barrier layer comprises about 85% vinylidene chloride-methyl acrylate comonomer and about 15% vinylidene chloride-vinyl chloride comonomer, as for example described in Schuetz et al. U.S. Pat. No. 4,798,751. Suitable and preferred EVOH copolymers are described in U.S. Pat. No. 5,759,648. The teachings of both the '751 and '648 patents are hereby incorporated by reference in their entireties.

The inner heat sealing layer 44 is generally provided on a side of the barrier layer 42 that becomes the inner surface 38, or bottom surfaces 15 and 115 shown in FIGS. 1-6, of the bags 10, 110 or 210. Other film layers may optionally be incorporated between the barrier layer 42 and the inner heat sealing layer 44 as previously noted. Substantially linear copolymers of ethylene and at least one alpha-olefin as well as copolymers of ethylene and vinyl esters or alkyl acrylates, such as vinyl acetate, may be usefully employed in one or more layers of the film, and may comprise monolayer and multilayer thermoplastic films. Preferably, the inner heat sealing layer comprises a blend of at least one ethylene-α-olefin copolymer (EAO), with ethylene vinyl acetate (EAO:EVA blend). Suitable α-olefins include C₃ to C₁₀ alpha-olefins such as propene, butene-1, pentene-1, hexene-1, methylpentene-1, octene-1, decene-1 and combinations thereof. The heat seal layer is optionally the thickest layer of a multilayer film and may significantly contribute to the puncture resistance of the film. Another desirable characteristic affected by this layer is the heat seal temperature range. It is preferred that the temperature range for heat sealing the film be as broad as possible. This allows greater variation in the operation of the heat sealing equipment relative to a film having a very narrow range. For example, it is desirable for a suitable film to heat seal over a broad temperature range providing a heat sealing window of 80° F. or higher.

The outer layer 46 is provided on the side of the barrier layer opposite the heat sealing layer 44 and acts as the outer surface 39. In the instance when a lap seal, such as the first seal 32 of bag 10 is incorporated into a bag structure, the outer layer 46 must be heat seal compatible with the inner heat sealing layer. Other polymer layers may optionally be provided between the barrier layer and the outer layer as previously discussed. The outer layer may comprise an ethylene-α-olefin copolymer (EAO), ethylene vinyl acetate copolymer (EVA) or blends thereof. EAOs are copolymers predominately comprising ethylene polymeric units copolymerized with less than 50% by weight of one or more suitable α-olefins which include C₃ to C,₀ alpha-olefins such as propene, butene-1, pentene-1, hexene-1, methylpentene-1, octene-1, decene-1. Preferred alpha-olefins are hexene-1 and octene-1. Recent developments for improving properties of a heat-shrinkable film include U.S. Pat. No. 5,403,668, incorporated herein, which discloses a multilayer heat-shrinkable oxygen barrier film wherein the film outer layer is a four component blend of VLDPE, LLDPE, EVA and plastomer. LLDPE, or linear low density polyethylene, is a class of ethylene-alpha olefin copolymers having a density greater than 0.915 g/cm³. VLDPE, also called ultra low density polyethylene (ULDPE), is a class of ethylene-alpha olefin copolymers having a density less than 0.915 g/cm³ and many commercial VLDPE resins are available having densities from 0.900 up to 0.915 g/cm³. Plastomers are generally EAOs having densities below 0.900 g/cm³. U.S. Pat. No. 5,397,640 discloses a multilayer oxygen barrier film wherein at least one outer film layer is a three component blend of VLDPE, EVA and a plastomer. Alternatively, the outer layer may be formed of other thermoplastic materials as for example polyamide, styrenic copolymers, e.g., styrene-butadiene copolymer, polypropylene, ethylene-propylene copolymer, ionomer, or an alpha olefin polymer and in particular a member of the polyethylene family such as linear low density polyethylene (LLDPE), very low density polyethylene (VLDPE and ULDPE), high density polyethylene (HDPE), low density polyethylene (LDPE), an ethylene vinyl ester copolymer or an ethylene alkyl acrylate copolymer or various blends of two or more of these materials.

In general, the monolayer or multilayer films used in the heat-shrinkable bags of the present invention can have any thickness desired, so long as the films have sufficient thickness and composition to provide the desired properties for the particular packaging operation in which the film is used, e.g., puncture-resistance, modulus, seal strength, barrier, optics, etc. For efficiency and conservation of materials, it is desirable to provide the necessary puncture-resistance and other properties using the minimum film thicknesses. Preferably, the film has a total thickness from about 1.25 to about 8.0 mils; more preferably from about 1.75 to about 3.0 mils.

Suitable films for use with the present invention are disclosed in U.S. Pat. No. 5,928,740, incorporated herein by reference thereto in its entirety. The '740 patent discloses a heat sealing layer comprising a blend of a first polymer of ethylene and at least one α-olefin having a polymer melting point between 55 to 75° C.; a second polymer of ethylene and at least one α-olefin having a polymer melting point between 85 to 110° C. and a third thermoplastic polymer having a melting point between 115 to 130° C. which is preferably selected from the group of ethylene homopolymers such as HDPE and LDPE, and ethylene copolymers with at least one α-olefin; and optionally and preferably a fourth polymer such as a copolymer of ethylene with an alkyl acrylate or vinyl ester having a melting point between 80 to 105° C., preferably 90 to 100° C. The '740 patent also discloses a preferred biaxially oriented, heat-shrinkable three-layer barrier film embodiment for use with the present invention. The three-layer barrier film embodiment comprises an inner heat sealing layer as described above in conjunction with a barrier layer preferably comprising a polyvinylidene chloride (PVDC) or vinylidene chloride methylacrylate copolymer (VDC-MA or MA-saran) or EVOH layer and an outer layer formed of at least 50 wt. %, and preferably at least 70%, of a copolymer of ethylene with at least one alpha-olefin or at least one vinyl ester or blends thereof. Also, preferred EVAs will have between about 3% and about 18% vinyl acetate content.

Preferred films for use with the present invention are disclosed in U.S. Patent Application Ser. No. 09/401,692 filed Sep. 22, 1999, and incorporated herein by reference in its entirety. The '692 application discloses monolayer and multilayer films having at least one layer comprising at least a three-polymer blend, optionally including a fourth polymer, comprising: (a) a first polymer having a melting point of 80 to 98° C., preferably 80-92° C., comprising a copolymer of ethylene and hexene-1; (b) a second polymer having a polymer melting point of 115 to 128° C. comprising ethylene and at least one α-olefin; and (c) a third polymer having a melting point of 60 to 110° C. comprising a copolymer of ethylene with an alkyl acrylate or vinyl ester; and optionally (d) a fourth polymer having a melting point of 80 to 110° C. (preferably of 85 to 105° C.), preferably selected from the group of ethylene homopolymers such as HDPE and LDPE, and ethylene copolymers with at least one α-olefin. The inventive blend finds utility as an inner heat sealing layer in many multilayer embodiments. In a preferred three, four or five-layer embodiment, an oxygen barrier layer of a vinylidene chloride copolymer, a polyamide or EVOH is between a layer of the inventive blend and either a layer comprising at least 50% by weight of an EAO or at least one vinyl ester or blends thereof, or another layer comprising the inventive blend.

Additional preferred films for use with the present invention are disclosed in U.S. patent application Ser. No. 09/611,192 filed Jul. 6, 2000, which is incorporated by reference herein in its entirety. The '192 application discloses multi-layer barrier embodiments formed of a flexible, thermoplastic, biaxially stretched, heat-shrinkable film having at least one layer comprising a blend of at least three copolymers comprising: 45 to 85 weight percent of a first polymer having a melting point of from 55 to 98° C. comprising at least one copolymer of ethylene and at least one comonomer selected from the group of hexene-1 and octene-1; 5 to 35 weight percent of a second polymer having a melting point of from 115 to 128° C. comprising at least one copolymer of ethylene and at least one α-olefin; and 10 to 50 weight percent of a third polymer having a melting point of from 60 to 110° C. comprising at least one unmodified or anhydride-modified copolymer of ethylene and a vinyl ester, acrylic acid, methacrylic acid, or an alkyl acrylate; where the first and second polymers above have a combined weight percentage of at least 50 weight percent based upon the total weight of the first, second and third polymers; and where the bag film has a total energy absorption of at least 0.70 Joule and a shrinkage value at 90° C. of at least 50% in at least one of the machine and transverse directions. A barrier layer formed of any suitable oxygen barrier material or blend of materials, for example, ethylene-vinyl alcohol copolymer (EVOH) or copolymers of vinylidene chloride (VDC) such as VDC-vinyl chloride (VDC-VC) or VDC-methylacrylate (VDC-MA) may be used. Preferably the barrier layer comprises a blend of 85 wt. % VDC-MA and 15 wt. % VDC-VC. The outer layer is preferably an EVA-VLDPE blend, and more preferably an EVA-VLDPE-plastomer blend. The '192 application also discloses a film comprising a flexible, thermoplastic film having at least one layer comprising a blend of at least two polymers comprising: 5 to 20 weight percent of (i) an ionomer polymer, e.g., an ethylene-methacrylate acid copolymer whose acid groups have been neutralized partly or completely to forma salt, preferably a zinc or sodium salt; 5 to 95 weight percent of (ii) a copolymer of ethylene and at least one C₆ to C₈ α-olefin, having a melting point of from 55 to 95° C., and a \overline{M}_{w}/\overline{M}ₙ of from 1.5 to 3.5; 0 to 90 weight percent of (iii) a copolymer of ethylene and at least one C₄ to C₈ α-olefin, having a melting point of from 100 to 125° C.; and 0 to 90 weight percent of (iv) a copolymer of propylene and at least one monomer selected from the group of ethylene and butene-1, where the copolymer (iv) has a melting point of from 105 to 145° C.; 0 to 90 weight percent of (v) a copolymer of ethylene and at least one monomer selected from the group of hexene-1, octene-1 and decene-1, where the copolymer (v) has a melting point of from 125 to 135° C.; and polymers (ii), (iii), (iv), and (v) have a combined weight percentage of at least 80 weight percent based upon the total weight of polymers (i), (ii), (iii), (iv), and (v); and wherein the film has a total energy absorption of at least 1.2 Joule. Optionally, the same blend may be used as an inner heat sealing layer for a bag film.

Further preferred films for use with the present invention are described in U.S. Pat. No. 5,302,402 to Dudenhoeffer et al., U.S. Pat. No. 6,171,627, Lustig et al. U.S. Pat. No. 4,863,769, and U.S. Pat. No. 6,015,235 to Kraimer et al., all of which are incorporated herein in their entireties.

In a preferred embodiment of the present invention, the heat-shrinkable bag is formed of a three-layer film. The three-layer film is preferably a biaxially oriented film including a barrier layer disposed between an inner heat sealing layer and an outer layer, as shown in FIG. 5. The inner heat sealing layer comprises a blend of about 37% of an ethylene-vinyl acetate (EVA) copolymer such as ESCORENE™ LD 701.ID available from Exxon Chemical Co., Houston, Tex., USA; about 24% VLDPE resin such as SCLAIR™ 10B available from Nova Chemicals, Ltd., Calgary, Alberta, Canada (0.77 dg/min Melt Index and 0.911 g/cm³ density); about 33% of a plastomer, such as EXACT™ 4053 available from Exxon Chemical Co., Houston, Tex., USA; about 4% slip/processing aid, such as Spartech A27023 (slip/processing aid in a VLDPE carrier resin); and about 2% of a processing stabilizer such as Spartech A32434 (available from Spartech Polycom of Washington, Pa., U.S.A.). The barrier layer comprises a blend of about 15% vinylidene chloride-vinyl chloride and about 85% vinylidene chloride-methacrylate, such as further described in U.S. Pat. No. 4,798,751. The outer layer comprises a blend of about 40% of an ethylene-vinyl acetate (EVA) copolymer such as ESCORENE™ LD 701.ID; about 33% of a plastomer, such as EXACT™ 4053; about 25% of a VLDPE resin, such as SCLAIR™ 10B; and about 2% of a processing aid/slip concentrate in a VLDPE carrier, such as Ampacet 501236, available from Ampacet Corporation, Tarrytown, N.Y., USA. The inner layer, barrier layer and outer layer represent about 57.7%, 17.7% and 25.1% respectively based on the total thickness of the three-layer film.

In another preferred embodiment of the present invention, the heat-shrinkable bag is formed of another three-layer biaxially oriented shrink film including a barrier layer disposed between an inner heat sealing layer and an outer layer, as shown in FIG. 5. The barrier layer preferably comprises a blend of about 15% vinylidene chloride-vinyl chloride and about 85% vinylidene chloride-methacrylate such as further described in U.S. Pat. No. 4,798,751. The barrier layer preferably comprises approximately 16.5% of the three-layer film's thickness. The inner heat sealing layer preferably comprises about 57.1 % of the film's thickness and comprises a blend of about 35.1 wt. % of an ethylene-hexene-1 copolymer such as EXACT™ 9519 (0.895 g/cm³ and 2.2 dg/min Melt Index available from Exxon Chemical Co., Houston, Tex., USA); about 36.5% of an ethylene-octene-1 copolymer such as ATTANE™ XU 61509.32 (a C₂C₈ (<10 wt. % C₈) VLDPE having a density of about 0.912 g/cm³ and 0.5 dg/min Melt Index available from Dow Chemical Co., Midland, Mich., USA); about 26.5% of an ethylene-vinyl acetate (EVA) copolymer such as ESCORENE™ LD 701.ID (an ethylene-vinyl acetate copolymer available from Exxon Chemical Co., Houston, Tex., USA and reportedly having a density of 0.93 g/cm³, a vinyl acetate content of 10.5 wt. %, a melt index of about 0.19 dg/min., and a melting point of about 97° C.); about 3% of a slip/processing aid such as Spartech A50050 (1.9% oleamide slip and an fluoroelastomer in a VLDPE carrier resin); and about 2% of a processing stabilizer such as Spartech A32434 (10% DIIT4A in VLDPE carrier resin available from Spartech Polycom of Washington, Pa., U.S.A.). The outer layer preferably comprises about 26.4% of the film thickness and comprises about 35 wt. % of an ethylene-hexene-1 copolymer such as EXACT™ 9519; about 35% of a ethylene-octene-1 copolymer such as ATTANE™ XU 61509.32; about 27% of a EVA copolymer such as ESCORENE™ LD 701.ID; and about 3% of a slip/processing aid such as Spartech A50050 (available from Spartech Polycom of Washington, Pa., U.S.A.).

In another preferred embodiment, the film of the bag comprises a biaxially oriented three-layer heat-shrinkable film having an inner heat sealing layer made of a blend of about 17 wt. % ethylene-octene-1 copolymer such as ATTANE™ XU 61509.32; about 18 wt. % EVA such ESCORENE™ LD 701.ID; 58% of an ethylene-hexene-1 copolymer such as EXACT™ 9110 (0.898 g/cm³ density, 0.8 dg/min Melt Index and 89° C. melting point); about 2% of a processing stabilizer such as Spartech A32434; and about 5% of a slip/processing aid such as Spartech A50050. The outer layer is about 19 wt. % ethylene octene-1 copolymer such as ATTANE™ XU 61509.32; 18% EVA (ESCORENE™ LD 701.ID); 60% of an ethylene-hexene-1 copolymer such as EXACT™ 9110; and 3% processing aid such as A50056. The barrier layer is 85% vinylidene chloride-methyl acrylate and about 15% vinylidene chloride-vinyl chloride. Preferably, the inner layer:barrier layer:outer layer thickness ratio is about 62:9:29.

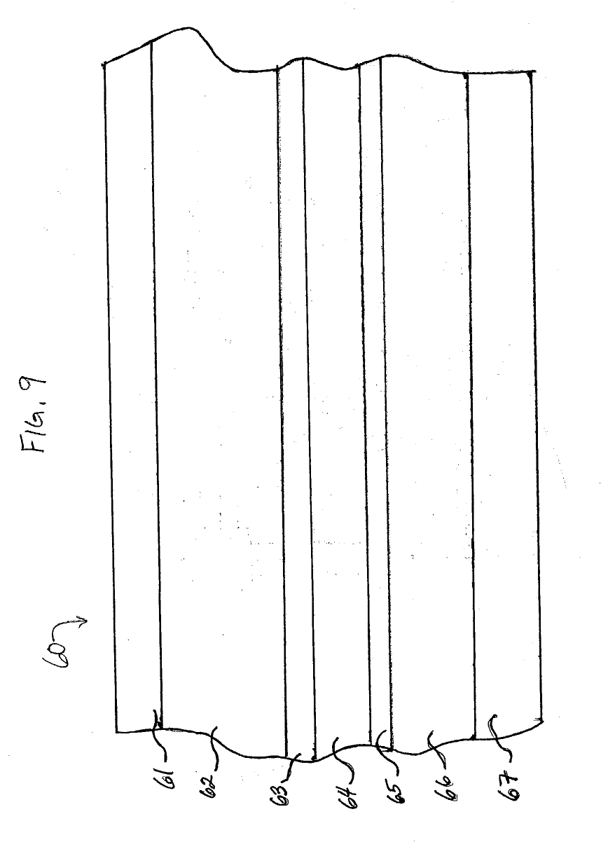

A preferred seven-layer film for use in fabricating bags according to the present invention is illustrated in FIG. 9 generally as film 60. The film 60 includes a first or inner heat sealing layer 61 preferably comprising about 10% of the total mass of the film 60. The inner heat sealing layer 61 preferably comprises a blend of about 94% EXACT™ 3139 (an ethylene-hexene copolymer having a reported Melt Index of 7.5 g/10 min and a density of 0.900 g/cm³); about 4% Spartech A27023; and about 2% Spartech A32434. A second layer 62, adjacent the first layer 61 preferably comprises about 42.2% of the total mass of the film and comprises a blend of about 37% ESCORENE™ LD 701.ID; about 33% EXACT 4053; about 24% SCLAIR™ 10B; about 4% Spartech A27023; and about 2% Spartech A32434. The film 60 further includes first and second tie layers 63 and 65, each of which individually preferably comprise about 5% of the total mass of the film 60 and further comprise about 100% of VORIDIAN™ SP1330, an ethylene-methyl acrylate copolymer available form Voridian, a division of Eastman Chemical Company, Kingsport, Tenn., USA. The film 60 includes a barrier layer 64 between the first and second tie layers 63. The barrier layer 64 preferably comprises about 17.7% of the total mass of the film and comprises a blend of about 85% vinylidene chloride-methyl acrylate and about 15% vinylidene chloride-vinyl chloride. Th film includes a third layer 66 that preferably comprises about 15.1% of the total mass of the film 60. The third layer 66 comprises a blend of about 40% ESCORENE™ 701.ID; about 33% EXACT™ 4053; about 25% SCLAIR™ 10B; and about 2% Spartech A27339. The film 60 includes a fourth layer or outer layer 67 that preferably comprises about 5% of the total mass of film 60 and comprises a blend of about 98% EXACT™ 3139 and about 2% Spartech A27339. The total thickness of the film 60 is preferably about 2 mils or greater.

Advantageously, it may be desirable to utilize high Melt Flow Index polymers in sealant layer(s) of the film to aid in transversely sealing across the lap, butt or fin seals. High Melt Flow polymers, having a Melt Flow Index greater than about 5 dg/min. The higher Melt Flow Index polymers fill gaps, such as gaps 9a (FIG. 2), 9b (FIG. 4) and 9c (FIG. 6) that may form due to the dimensional difference encountered when the second seals 32, 132 or 232 are between the first and second bag walls in the area of the first seals 16, 116 and 216, more readily than lower Melt Flow Index polymers. For example, other, high Melt Index polymers, such as EXACT™ 3040, which has a reported Melt Index of 16.5 g/10 min, could be used in the imner and outer layers 61 and 67 of film 60 to replace the lower Melt Index ethylene-hexene copolymer.

The films selected to fabricate the inventive receptacles are preferably biaxially oriented by the well-known trapped bubble or double bubble technique as for example described in Pahlke U.S. Pat. No. 3,456,044. In this technique an extruded primary tube leaving the tubular extrusion die is cooled, collapsed and then preferably oriented by reheating and reinflating to form a secondary bubble. The film is preferably biaxially oriented wherein transverse (TD) orientation is accomplished by inflation to radially expand the heated film. Machine direction (MD) orientation is preferably accomplished with the use of nip rolls rotating at different speeds to pull or draw the film tube in the machine direction.

The stretch ratio in the biaxial orientation to form the bag material is preferably sufficient to provide a film with total thickness of between about 1.5 and 3.5 mils. The MD stretch ratio is typically 3:1-5:1 and the TD stretch ratio is also typically 3:1-5:1.

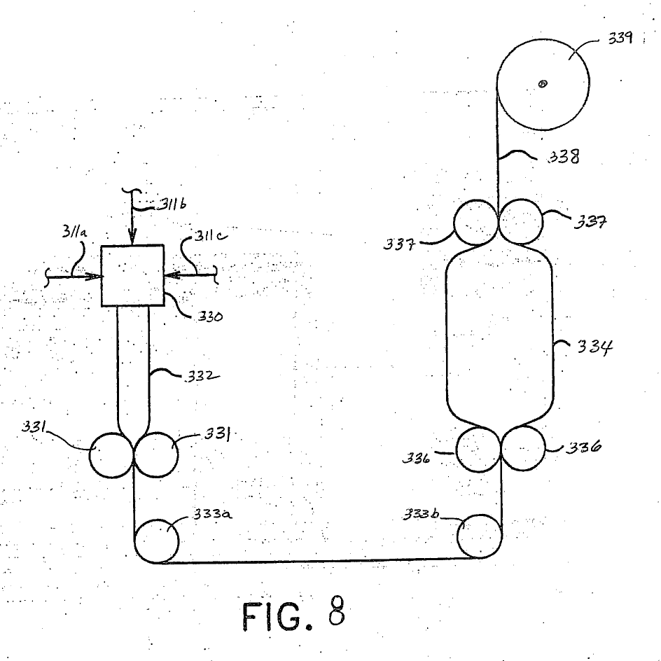

Referring now to FIG. 8, a double bubble or trapped bubble process is shown. The polymer blends making up the several layers are coextruded by conveying separate melt streams 311a, 311b, and 311c to the die 330. These polymer melts are joined together and coextruded from annular die 330 as a relatively thick walled multilayered tube 332. The thick walled primary tube 332 leaving the extrusion die is cooled and collapsed by nip rollers 331 and the collapsed primary tube 332 is conveyed by transport rollers 333a and 333b to a reheating zone where tube 332 is then reheated to below the melting point of the layers being oriented and inflated with a trapped fluid, preferably gas, most preferably air, to form a secondary bubble 334 and cooled. The secondary bubble 334 is formed by a fluid trapped between a first pair of nip rollers 336 at one end of the bubble and a second pair of nip rollers 337 at the opposing end of the bubble. The inflation which radially expands the film provides transverse direction (TD) orientation. Orientation in the machine direction (MD) is accomplished by adjusting the relative speed and/or size of nip rollers 336 and nip rollers 337 to stretch (draw) the film in the machine direction. Rollers 337 also collapse the bubble forming an oriented film 338 in a lay-flat condition which may be wound on a reel 339 or slit for further processing close up.

The biaxial orientation preferably is sufficient to provide a multilayer film with a total thickness of from about 1.25 to about 8.0 mils, preferably 1.5 to 4 mils or more, preferably between 1.75 and 3.0 mils (44 to 76μ), and more preferably about 2.5 mils.

A preferred film and process for making film suitable for use in fabricating bags according to the present invention is described in each of U.S. patent applications Ser. No. 09/401,692 filed Sep. 22, 1999 for “Puncture Resistant Polymeric Films, Blends and Process”; Ser. No. 09/431,931 filed Nov. 1, 1999 for “Puncture Resistant High Shrink Film, Blend and Process”; and Ser. No. 09/611,192 filed Jul. 6, 2000 for “Ionomeric, Puncture Resistant Thermoplastic Patch Bag, Film, Blend and Process”, the teachings of all of which are hereby incorporated by reference herein.

For a monolayer film, the process is similar but utilizes a single extruder (or multiple extruders running the same polymeric formulation) to produce a primary tube, and biaxial orientation is sufficient to provide a monolayer film preferably having a total thickness of between 2 to 6 mil or higher, and more typically from about 3.5 to 4.5 mils and is generally in the same draw ratio range as previously discussed, namely about 3:1 to 5:1 for both the MD and TD.

Although not essential, it is preferred to irradiate the film to broaden the heat sealing range and/or enhance the toughness properties of the inner and outer layers by irradiation induced cross-linking and/or scission. This is preferably accomplished by irradiation with an electron beam at a dosage level of at least 2 megarads (MR) and preferably in the range of 3-5 MR, although higher dosages may be utilized, such as for thicker films. Irradiation may be provided on the primary tube or after biaxial orientation. The latter, called post-irradiation, is preferred and described in Lustig et al. U.S. Pat. No. 4,737,391, which is hereby incorporated by reference.

After orientation, the tubular film 338 is collapsed, slit open longitudinally, laid flat and wound on a reel 339 for use as rollstock. One skilled in the art will appreciate that the above method may be used to form the film, films may be made by conventional single bubble, blown film processes, and oriented or nonoriented sheets may be made by slot cast sheet extrusion processes with or without tentering to provide orientation. One skilled in the art will further appreciate that the flatwidth of the collapsed tube will determine the width of the sheet film that results therefrom. Thus, the primary tube dimensions and subsequent processing may be selected to provide a maximum flatwidth and film thickness for the desired application, thereby advantageously maximizing the production capacity of the film making equipment.

Advantageously, a bag maker may produce bags of various lengths and widths from rolls of film rollstock by adjusting the width of the sheet (by slitting or cutting rollstock to a desired width) and the distances between the transverse end seal and bag mouth for a particular bag or series of bags. This advantageously avoids the costly need to produce specific widths of seamless tubes which are currently widely used by meat packers. Also the present invention permits cost savings and manufacturing efficiencies by permitting creation of numerous widths and lengths of bag from standard rollstock, which was produced utilizing substantially 100% of the film producing equipment's capacity. This reduces the need to carry larger inventories of a vast array of seamless tube rollstock having different widths. The bag maker may simply slit film rollstock to a desired width and form a continuous tube member by longitudinally sealing opposing side edges as described for bags 10, 110 and 210. Bags of adjustable lengths may be made by transversely sealing and cutting through the tube member at a position spaced from the transverse seal. The film may also be made into a continuous tube member rollstock by longitudinally joining opposing side edges of a film as described above to form a continuous tube member, collapsing the continuous tube member and winding the collapsed continuous tube member on a reel. The continuous tube member rollstock may then be provided to the food processor, who then forms the individual bags, such as bags 10, 110 and 210. Such continuous tube member rollstock may have a lay-flat width of up to 20 inches, advantageously greater than 20 inches, and more advantageously greater than or equal to 22 inches.

Preferably, bag making is a continuous process, wherein the film is directed to a bag making assembly (not shown) where individual end-seal bags are made. As previously stated, the rollstock may be slit to a desired width with the unused portion re-wound for later use. Bags are produced by continuously bringing the opposing side edges of the film together and forming a heat seal, such as a lap seal or fin seal to form a continuous tube member, then making lateral, or transverse, heat seals across the tube member width at spaced intervals to weld the first and second bag walls of the tube member together. The tube member is severed preferably at the same time or during the same step that it is transversely heat sealed to form a bag as shown in FIG. 1, 3 or 5. Typically as the transverse seal is made for one bag a transverse cut forming the mouth of the adjacent bag is being made. This process forms a so called “end-seal” bag which, when it is laid flat, has a bottom edge formed by the transverse heat seal, an open mouth formed by the severed edge and two side edges formed by the fold produced when the tube member is laid flat. The transverse heat seal should extend across the entire tube member to ensure a hermetic closure. Each bag being formed from a length of the tube member will necessarily be formed by at least two, usually parallel, spaced apart, transverse cuts which cause a segment of the tube member to be made and one transverse seal, usually adjacent one of these cuts, will define a bag bottom which is located opposing the bag opening, which is formed by the distal cut. In typical production the member tube is transversely sealed and an adjacent transverse cut made as part of the same step and the seal and this proximate cut form a sealed end for one bag while the same cut also forms the mouth opening for the adjacent bag, and for that adjacent bag may be referred to as the distal cut. The spacing between the lateral seal and the point of severance, which may vary, will determine the length of the bags formed. The length of the bags can easily be varied by changing the distance between cuts. The width of the bags can also be easily varied by changing the width of the film by slitting the standard rollstock. In another embodiment of the invention, cuts and seals may be made alternately and apart from each other to form dual attached bags in saddle bag fashion.

The present invention advantageously provides for producing a heat-shrinkable bag wherein the bag manufacturer may produce multiple bag sizes (different lengths and widths) from a single film stock size, which advantageously maximizes film production efficiency by eliminating the need to manufacture different widths of seamless tubes. In other words, the present invention allows the bag manufacturer to produce one standard width of sheet film stock, such as 86, 94, 98, 104, 112, 126, 162 inch or greater, depending on the capacity of the film producing equipment. This standard sheet film stock may then be slit to a desired width, formed into a bag as described herein, and the remaining portion of the sheet film stock rewound for later use on another job. Prior art bags require the manufacturer thereof to produce different seamless tube sizes for each size of bag produced, thereby reducing production efficiency.

Unless otherwise noted, the following physical properties are used to describe the invention, films and seals. These properties are measured by either the test procedures described below or tests similar to the following methods.

Average Gauge: ASTM D-2103

Tensile Strength: ASTM D-882, method A

1% Secant Modulus: ASTM D-882, method A

Oxygen Gas Transmission Rate (O₂GTR): ASTM D-3985-81

Percent Elongation at Break: ASTM D-882, method A

Molecular Weight Distribution: Gel permeation chromatography

Gloss: ASTM D-2457, 45° Angle

Haze: ASTM D-1003-52

Melt Index: ASTM D-1238, Condition E (190° C.) (except for propene-based (>50% C₃ content)

polymers tested at Condition L(230° C.))

Melting Point: ASTM D-3418, peak m.p. determined by DSC with a 10° C./min. heating rate.

Vicat Softening Point (Vsp): ASTM D-1525-82

Seal Strength: ASTM F88-94

All ASTM test methods noted herein are incorporated by reference into this disclosure.

Shrinkage Values: Shrinkage values are obtained by measuring unrestrained shrink of a 10 square sample immersed in water at 90° C. (or the indicated temperature if different) for ten seconds. Four test specimens are cut from a given sample of the film to be tested. Specimens are cut into squares of 10 cm length (M.D.) by 10 cm. length (T.D.). Each specimen is completely immersed for 10 seconds in a 90° C. (or the indicated temperature if different) water bath. The specimen is then removed from the bath and the distance between the ends of the shrunken specimen is measured for both the M.D. and T.D. directions. The difference in the measured distance for the shrunken specimen and each original 10 cm. side is multiplied by ten to obtain percent shrinkage in each direction. The shrinkage of 4 specimens is averaged and the average M.D. and T.D. shrinkage values reported. The term “heat shrinkable film at 90° C.” means a film having an unrestrained shrinkage value of at least 10% in at least one direction.

### Tensile Seal Strength (Seal Strength) Test

Five identical samples of film are cut 1 inch (2.54 cm) wide and a suitable length for the test equipment e.g. about 5 inches (77 cm) long with a 1 inch (2.54 cm) wide seal portion centrally and transversely disposed. Opposing end portions of a film sample are secured in opposing clamps in a universal tensile testing instrument. The film is secured in a taut snug fit between the clamps without stretching prior to beginning the test. The test is conducted at an ambient or room temperature (RT) (about 23° C.) test temperature. The instrument is activated to pull the film via the clamps transverse to the seal at a uniform rate of 12.0 inches (30.48 cm) per minute until failure of the film (breakage of film or seal, or delamination and loss of film integrity). The test temperature noted and lbs. force at break are measured and recorded. The test is repeated for four additional samples and the average grams at break reported.

### Ram Puncture Test

The ram puncture test is used to determine the maximum puncture load or force, and the maximum puncture stress of a flexible film when struck by a hemispherically or spherically shaped striker. This test provides a quantitative measure of the puncture resistance of thin plastic films. This test is further described in U.S. patent application Ser. No. 09/401,692.

The following example is given to illustrate the invention and should not be construed as limiting that which is described in the appended claims.

In the following example, the film composition was produced generally utilizing the apparatus and method described in U.S. Pat. No. 3,456,044 (Pahlke) which describes a coextrusion type of double bubble method and in further accordance with the detailed description above. All layers were extruded as a primary tube which was cooled upon exiting the die e.g. by spraying with tap water. This primary tube was then reheated by radiant heaters(although other means known to those skilled in the art, such as conduction or convection heating may be used) with further heating to the draw (orientation) temperature for biaxial orientation accomplished by an air cushion which was itself heated by transverse flow through a heated porous tube concentrically positioned around the moving primary tube. Cooling was accomplished by means of a concentric air ring. Draw point temperature, bubble heating and cooling rates and orientation ratios were generally adjusted to maximize bubble stability and throughput for the desired amount of stretching or orientation. All percentages are by weight unless indicated otherwise.

### EXAMPLE

A puncture-resistant bag according to the present invention, as generally illustrated in FIGS. 1 & 2, was produced from a film comprising a coextruded three-layer biaxially oriented shrink film having (A) an inner heat sealing layer, (B) a barrier layer and (C) an outer layer. The inner and outer layers being directly attached to opposing sides of the barrier layer. The three layers included the following compositions:

(A) 33 wt. % EXACT™ 4053; 37% ESCORENE™ LD 701.ID; 24% SCLAIR™ 10B; 4% Spartech A27023; and 2% Spartech A32434;

(B) a blend of about 85% vinylidene chloride-vinyl chloride copolymer and about 15% vinylidene chloride-methacrylate copolymer; and

(C) 33 wt. % EXACT™ 4053; 25% SCLAIR™ 10B; 40% ESCORENE™ LD 701.ID; and 2% Ampacet 501236.

One extruder was used for each layer. Each extruder was connected to an annular coextrusion die from which heat plastified resins were coextruded forming a primary tube. The resin mixture for each layer was fed from a hopper into an attached single screw extruder where the mixture was heat plastified and extruded through a three-layer coextrusion die into the primary tube. The extruder barrel temperature for the barrier layer (B) was between about 250-300° F. (121-149° C.); for the inner layer (A) and for the outer layer (C) were about 290-330° F. (143-165° C.). The coextrusion die temperature profile was set from about 320 to 350° F. (163 to 177° C.). The extruded multilayer primary tube was cooled by spraying with cold tap water 50-68° F. (about 10-20° C.).

A cooled primary tube of about 4 inches flatwidth was produced passing through a pair of nip rollers. The cooled flattened primary tube was inflated, reheated, biaxially stretched, and cooled again to produce a biaxially stretched and biaxially oriented film which was slit open, laid flat to form a sheet having a width of approximately 16 inches and wound on a reel. The M.D. orientation ratio was about 5:1 and the T.D. orientation ratio was about 4:1. The draw point or orientation temperature was below the predominant melting point for each layer oriented and above that layer's predominant glass transition point and is believed to be about 68-85° C. The resultant biaxially oriented film had an average gauge of about 2.5 mil and had an excellent appearance.

The film was irradiated at a dosage level of about 5.0 MR. As previously noted, although not essential, it is preferred to irradiate the entire film to broaden the heat sealing range and/or enhance the toughness properties of the inner and outer layers by irradiation induced cross-linking and/or scission. Irradiation may be done on the primary tube or after biaxial orientation. The latter, called post-irradiation, is preferred and described in Lustig et al. U.S. Pat. No. 4,737,391, which is hereby incorporated by reference. An advantage of post-irradiation is that a relatively thin film is treated instead of the relatively thick primary tube, thereby reducing the power requirement for a given treatment level.

The film was unwound and slit to a width of 13 inches. The film was then fed into the bag making equipment to form a tube member having a continuous longitudinally extending lap seal. Bags according to the bag 10 depicted in FIG. 1 were formed by sealing laterally across the tube member and simultaneously severing the sealed portion from the continuous tube structure.

Various tests were performed on the film and/or resultant inventive bags. The film thickness was determined to be an average 2.1 mil. The lap seal was tested to have a very strong average seal strength of about 8,000 to 10,000 grams. The bag also had an average M.D. and T.D. heat shrinkability at 90° C. of 48 and 48, respectively. The ram puncture results were likewise impressive. The puncture resistance of the 2.1 mil thick film was measured and had a maximum puncture force of 86 Newtons (N) and a total energy to failure of 0.9 Joules (J). This preferred bag has very good heat shrink percentages which are highly desirable for packaging cuts of fresh red meat and extremely good puncture resistance. Thus, an economical to produce heat shrinkable bag having puncture resistance and strong seals has been made having a unique combination of features and commercial advantages previously unknown.

Advantageously, the bags 10 and 110 may be fabricated of nearly any dimensions economically since the bags 10 and 110 are not formed from a seamless tube that must be generated to the desired width. The only limitation on size of fabricated bag is the size of a stock sheet films having great enough widths to meet the specifications. Standard roll stock films are available in widths in excess of 100 inches. The present invention allows a bag manufacturer to fabricate any size bag from the same flat sheet of roll stock, up to the dimensional limits of the roll stock. For example, if the roll stock is 52 inches in width, a tube member can be fabricated having a lay-flat width of approximately 26 inches, less the amount of overlap or abutment in the first seal 16 or 116 used. If the manufacturer wishes to fabricate a bag having a lay-flat width of 18 inches, then the manufacturer slits the standard roll stock to the appropriate width (approximately 36 plus extra for the area of the first seal 16 or 116). The unused portion slit form the standard roll stock is rewound for use making bags of another dimension(s). In this manner, standard roll stock films can be manufactured more economically because film manufacturing equipment may be run at or near the upper limits of film width production and thereby use nearly all the equipments capacity. Fabricating bags from seamless tubes requires that the film making equipment be run at limited capacities to form the different smaller width tubes. Additionally, the film making equipment requires costly set-up and breakdown between jobs of differing dimensions that add significantly to the cost of manufacturing the seamless tubes.

While this invention has been described with reference to certain specific embodiments, it will be recognized by those skilled in the art that many variations are possible without departing from the scope and spirit of the invention and such variations are deemed to be within the scope of the invention claimed below.

What is claimed is:

1. An individual end-sealed packaging receptacle formed from a sheet of a heat-shrinkable film, said film having a first edge and an opposing second edge, said receptacle comprising:
a first seal bonding said first edge and said second edge thereby defining a tube member having a first tube wall, a second tube wall, opposing first and second lay-flat edges, an end and an open mouth, said first seal being positioned between said first and second lay-flat edges;
a second seal provided through said first and second tube walls, said second seal extending laterally across the width of both said first and second walls at a position approximate said end, whereby an empty product receiving chamber is defined by said first wall, said second wall, said second seal and said open mouth.

2. The receptacle according to claim 1, wherein said first seal comprises a fin seal.

3. The receptacle according to claim 1, wherein said first seal comprises a lap seal.

4. The receptacle according to claim 1, wherein said first seal comprises a butt-seal.

5. The receptacle according to claim 1, wherein said film has a thickness from about 1.5 mil to about 4.0 mil.

6. The receptacle according to claim 1, wherein said film comprises a biaxially stretched film having a shrinkage value of at least 30% shrink at 90° C. in at least one direction.

7. The receptacle according to claim 6, wherein said shrinkage value is in the machine direction.

8. The receptacle according to claim 6, wherein said biaxially stretched film comprises a multilayer film having an inner layer, a core layer and an outer layer.

9. The receptacle according to claim 8, wherein said core layer comprises a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof.

10. The receptacle according to claim 1, wherein said biaxially stretched film comprises a seven-layer film.

11. The receptacle according to claim 10, wherein said seven-layer film comprises an inner layer/a second layer/a first tie layer/a barrier layer/a second tie layer/a third layer/an outer layer structure.

12. The receptacle according to claim 11, wherein said barrier layer comprises a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof.

13. The receptacle according to claim 11, wherein said first tie layer comprises an ethylene-methyl acrylate copolymer.

14. The receptacle according to claim 11, wherein said second tie layer comprises an ethylene-methyl acrylate copolymer.

15. The receptacle according to claim 11, wherein said inner layer comprises a polyolefin having a Melt Index of at least 7.0 g/10 min.

16. The receptacle according to claim 11, wherein said outer layer comprises a polyolefin having a Melt Index of at least 16.0 g/10 min.

17. The receptacle of claim 1, wherein said bag includes indicia thereon.

18. The receptacle of claim 17, wherein said indicia is printed.

19. An end-sealed packaging receptacle formed from a sheet of a heat-shrinkable film, said film having a first edge and an opposing second edge, said receptacle comprising:
a first seal bonding said first edge and said second edge and defining a tube member having a first tube wall, a second tube wall, opposing first and second lay-flat edges, a closed end and an open mouth, said first seal comprising a lap seal;
a second seal provided through said first and second walls, said second seal extending laterally across the width of both said first and second walls at a position approximate said end, whereby a product receiving chamber is defined by said first wall, said second wall, said second seal and said open mouth.

20. An end-sealed packaging receptacle formed from a sheet of a heat-shrinkable film, said film having a first edge and an opposing second edge, said receptacle comprising:
a first seal bonding said first edge and said second edge and defining a tube member having a first tube wall, a second tube wall, opposing first and second lay-flat edges, a closed end and an open mouth, said first seal comprising a butt-seal;
a second seal provided through said first and second walls, said second seal extending laterally across the width of both said first and second walls at a position approximate said end, whereby a product receiving chamber is defined by said first wall, said second wall, said second seal and said open mouth.

21. A method of forming an individual, end-sealed, heat-shrinkable packaging receptacle from a flat sheet of film, said method comprising the steps of:
(a) providing a heat-shrinkable thermoplastic film having a first edge and an opposed second edge;
(b) bringing said first and second edges together;
(c) forming a first seal joining said first and second edges to form a tube member having a first tube wall, a second tube wall, a bottom and an open mouth; and,
(d) providing a second seal through said first and second tube walls, said second seal extending laterally across said tube member at a position approximate said bottom.

22. The method of claim 21, wherein said heat-shrinkable thermoplastic film includes an indicia.

23. The method according to claim 21, wherein said first seal comprises a lap seal.

24. The method according to claim 21, wherein said first seal comprises a butt-seal.

25. The method according to claim 21, wherein said first seal comprises a fin seal.

26. The method according to claim 21, wherein said flat sheet of film is slit to a desired width prior to bringing said first and second edges together.

27. The method according to claim 21, wherein said heat-shrinkable thermoplastic film has a shrinkage value of at least 30% at 90° C. in at least one direction.

28. The method of claim 21, wherein said method further includes the step of providing a cut laterally through said tube member, said cut extending laterally across at least the width of both first and second tube walls to separate said receptacle from said continuous roll of flat sheet film.

29. The method according to claim 21, wherein said heat-shrinkable thermoplastic film is formed by coextruding a primary film tube, cooling the primary film tube, collapsing the primary film tube, inflating the primary tube, reheating the inflated primary film tube, biaxially stretching the primary film tube, cooling the primary film tube, recollapsing the primary film tube and slitting the primary film tube to produce a sheet of film.

30. The method of claim 21, wherein said first seal is linear.

31. The method of claim 21, wherein said second seal and said cut are curved.

32. The method of claim 21, wherein said first seal has a seal strength of at least 8,000 g.

33. The method of claim 28, wherein said cut is provided prior to providing said second seal.

34. A method of forming a heat-shrinkable bag comprising the steps of:
(a) coextruding a primary film tube;
(b) biaxially stretching said film tube to provide a heat-shrinkable film tube stock;
(c) slitting said tube stock to form a continuous sheet of film;
(d) slitting said continuous flat sheet of film longitudinally to form a desired-width bag film; said desired-width bag film having a first edge and an opposing second edge;
(e) sealing said first and second edges to form a tube member having a first wall, a second wall and a product receiving chamber defined between said first and second walls;
(f) providing a first lateral seal through said first and second walls, said seal extending laterally across the width of said tube member; and
(g) providing a cut through said tube member, said cut extending laterally across the width of said tube member, whereby a bag is formed having a bag mouth on one end formed by said cut and having said first lateral seal proximate a bag end at an opposing end from said bag mouth.

35. The method according to claim 34, wherein said continuous sheet of film is wound onto a roll prior to being slit to form said desired-width bag film.

36. A tubular film for producing end-sealed packaging receptacles, said tubular film formed from a sheet of a heat-shrinkable film, said film having a first edge and an opposing second edge, said tubular film comprising:
a first seal longitudinally joining said first edge and said second edge and defining a tube member having a first tube wall, a second tube wall and opposing first and second lay-flat edges; said first seal selected from the group consisting of a lap seal, a butt-seal and a fin seal, wherein said tube member has a lay-flat width of greater than or equal to 22 inches.

37. The tubular film according to claim 36, wherein said film has a thickness from about 1.5 mil to about 4.0 mil.

38. The tubular film according to claim 36, wherein said film comprises a biaxially stretched film having a shrinkage value of at least 20% shrink at 90° C. in at least one direction.

39. A tubular film for producing end-sealed packaging receptacles, said tubular film formed from a sheet of a heat-shrinkable film, said film having a first edge and an opposing second edge, said tubular film comprising:
a first seal longitudinally joining said first edge and said second edge and defining a tube member having a first tube wall, a second tube wall and opposing first and second lay-flat edges;
said first seal selected from the group consisting of a lap seal, a butt-seal and a fin seal, wherein said tube member includes an indicia thereon.

40. The tubular film according to claim 39, wherein said indicia indicates a bone-containing product is contained therein.

41. The tubular film according to claim 39, wherein said film has a thickness from about 1.5 mil to about 4.0 mil.

42. The tubular film according to claim 39, wherein said film comprises a biaxially stretched film having a shrinkage value of at least 20% shrink at 90° C. in at least one direction.

43. A tubular film for producing end-sealed packaging receptacles, said tubular film formed from a sheet of a heat-shrinkable film, said film having a first edge and an opposing second edge, said tubular film comprising:
a first seal longitudinally joining said first edge and said second edge and defining a tube member having a first tube wall, a second tube wall and opposing first and second lay-flat edges; said first seal selected from the group consisting of a lap seal, a butt-seal and a fin seal, wherein said tube member has a lay-flat width of greater than or equal to 22 inches and said tube member includes an indicia thereon.
